(19) United States
(12) Patent Application Publication
(10) Pub. No.: US 2024/0333017 A1
(43) Pub. Date: Oct. 3, 2024

(54) POWER CONVERTER

(71) Applicant: KABUSHIKI KAISHA TOYOTA JIDOSHOKKI, Aichi-ken (JP)

(72) Inventor: Takahiro SUZUKI, Kariya-shi (JP)

(73) Assignee: KABUSHIKI KAISHA TOYOTA JIDOSHOKKI, Aichi-ken (JP)

(21) Appl. No.: 18/609,353

(22) Filed: Mar. 19, 2024

(30) Foreign Application Priority Data
Mar. 29, 2023 (JP) 2023-053388

(51) Int. Cl. H02J 7/04; B60L 53/22; H02J 7/00

(52) U.S. Cl. CPC H02J 7/04; B60L 53/22; H02J 7/0068; H02J 2207/20; H02J 2310/48

(57) ABSTRACT

A power converter includes a charger that converts AC power into DC power, a battery connected to the charger and supplied with DC power from the charger, an inverter connected to the battery and supplied with DC power from the battery, and a motor connected to the inverter and including three star-connected coils. The motor is supplied with AC power from the inverter. A positive conductor connects the charger to a positive electrode of the battery. A negative conductor connects the charger to a negative electrode of the battery. A first switching unit in the positive conductor connects the charger and the battery. A connection line connects a node between the charger and the first switching unit in the positive conductor to a neutral point of the motor. A second switching unit arranged in the connection line connects the positive conductor and the neutral point of the motor.

### BACKGROUND

### Field

The following description relates to a power converter.

### Description of Related Art

Japanese Laid-Open Patent Publication No. 2017-11993 discloses a charger that converts AC power input from an AC power supply into DC power and outputs the DC power to a battery. The charger charges the battery by outputting voltage that is higher than the voltage across the terminals of the battery.

Batteries may have different nominal voltages. For example, vehicle batteries may have nominal voltages that vary in accordance with the vehicle type. Thus, a charger that is applicable to batteries of different nominal voltages has a wide output voltage range.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a power converter includes a charger configured to convert input alternating current (AC) power into direct current (DC) power, a battery connected to the charger and supplied with DC power that is output from the charger, an inverter connected to the battery and configured to be supplied with DC power that is output from the battery, and a motor connected to the inverter and including three star-connected coils. The motor is configured to be supplied with AC power that is output from the inverter. The power converter further includes a positive conductor connecting the charger to a positive electrode of the battery, a negative conductor connecting the charger to a negative electrode of the battery, a first switching unit arranged in the positive conductor and configured to connect or disconnect the charger and the battery, a connection line connecting a node between the charger and the first switching unit in the positive conductor to a neutral point of the motor, and a second switching unit arranged in the connection line and configured to connect or disconnect the positive conductor and the neutral point of the motor.

Other features and aspects will be apparent from the following detailed description, the drawings, and the claims.

### BRIEF DESCRIPTION OF THE DRAWINGS

FIG. 1 is a circuit diagram of a power converter.

FIG. 2 is a circuit diagram of the power converter when propelling a vehicle.

FIG. 3 is a flowchart illustrating charge control executed by a controller shown in FIG. 1.

FIG. 4 is a circuit diagram of the power converter when determined in the charge control of FIG. 3 that the voltage that is to be supplied to a battery is less than or equal to a threshold voltage.

FIG. 5 is a circuit diagram of the power converter when determined in the charge control of FIG. 3 that the voltage that is to be supplied to the battery is greater than the threshold voltage.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

One embodiment of a power converter will now be described. In this example, the power converter is installed in a vehicle.

### Power Converter

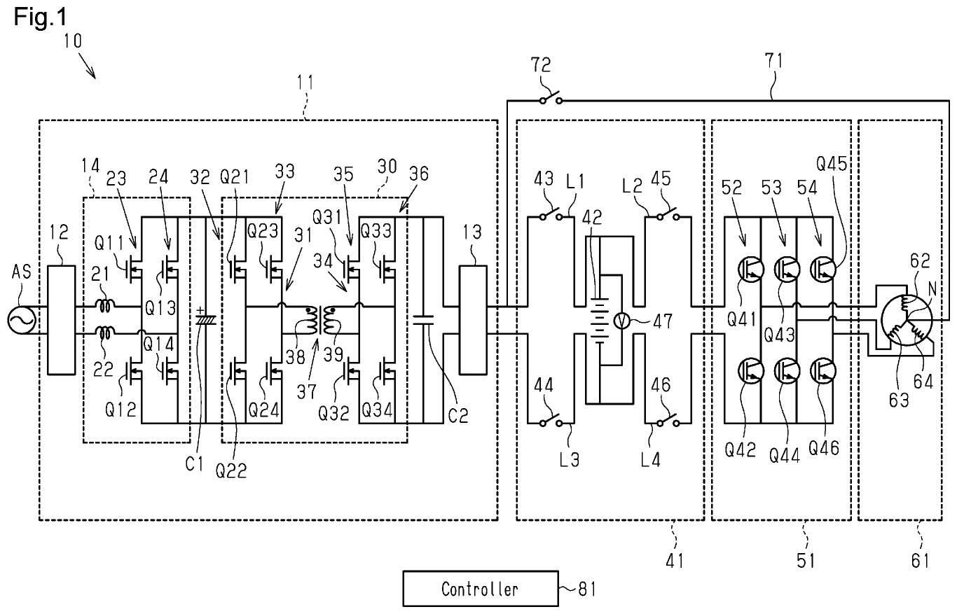

As shown in FIG. 1, a power converter 10 includes a charger 11, a battery pack 41, an inverter 51, and a motor 61.

The charger 11 converts input alternating current (AC) power into direct current (DC) power. In this embodiment, the charger 11 includes an AC filter 12, an AC/DC converter 14, a capacitor C1, a DC/DC converter 30, a capacitor C2, and a DC filter 13.

An external AC power supply AS, which is located outside a vehicle, supplies AC power that is input to the charger 11. The input AC power from the external AC power supply AS may be three-phase AC or single-phase AC.

The AC filter 12 reduces noise emitted from the external AC power supply AS.

The AC/DC converter 14 includes two reactors 21 and 22 and two series-connected bodies 23 and 24. A first end of the reactor 21 and a first end of the reactor 22 are connected to the AC filter 12. This connects the reactors 21 and 22 via the AC filter 12 to the external AC power supply AS.

The two series-connected bodies 23 and 24 are connected in parallel to each other. The series-connected body 23 includes two switching elements Q11 and Q12 that are connected in series to each other. A second terminal of the reactor 21 is connected to a node of the two switching elements Q11 and Q12. The switching elements Q11 and Q12 are, for example, semiconductor switching elements. A semiconductor switching element is, for example, a metal-oxide semiconductor field-effect transistor MOSFET), an insulated-gate bipolar transistor (IGBT), a gallium nitride high electron mobility transistor (Gan HEMT), or the like.

The series-connected body 24 includes two switching elements Q13 and Q14 that are connected in series to each other. A second terminal of the reactor 22 is connected to a node of the two switching elements Q13 and Q14. The switching elements Q13 and Q14 are, for example, semiconductor switching elements.

The AC/DC converter 14 improves the power factor, while converting the input AC power, which is received via the AC filter 12, into DC power.

The capacitor C1 is arranged between the AC/DC converter 14 and the DC/DC converter 30. The capacitor C1 is a link capacitor or a smoothing capacitor.

One end of the capacitor C1 is connected to a node of the switching elements Q11 and Q13.

The other end of the capacitor C1 is connected to a node of the two switching elements Q12 and Q14.

The series-connected bodies 23 and 24 are connected in parallel to the capacitor C1.

The DC/DC converter 30 includes a first bridge circuit 31, a second bridge circuit 34, and a transformer 37. The first bridge circuit 31 includes two series-connected bodies 32 and 33. The two series-connected bodies 32 and 33 are connected in parallel to each other. The series-connected body 32 includes two switching elements Q21 and Q22 that are connected in series to each other. The switching elements Q21 and Q22 are, for example, semiconductor switching elements.

The series-connected body 33 includes two switching elements Q23 and Q24 that are connected in series to each other. The switching elements Q23 and Q24 are, for example, semiconductor switching elements.

A node of the two switching elements Q21 and Q23 is connected to one end of the capacitor C1.

A node of the two switching elements Q22 and Q24 is connected to the other end of the capacitor C1.

The series-connected bodies 32 and 33 are connected in parallel to the capacitor C1.

The second bridge circuit 34 includes two series-connected bodies 35 and 36. The two series-connected bodies 35 and 36 are connected in parallel to each other. The series-connected body 35 includes two switching elements Q31 and Q32 that are connected in series to each other. The switching elements Q31 and Q32 are, for example, semiconductor switching elements.

The series-connected body 36 includes two switching elements Q33 and Q34 that are connected in series to each other. The switching elements Q33 and Q34 are, for example, semiconductor switching elements.

The transformer 37 includes a first winding 38 and a second winding 39. One end of the first winding 38 is connected to a node of the two switching elements Q21 and Q22. The other end of the first winding 38 is connected to a node of the two switching elements Q23 and Q24. One end of the second winding 39 is connected to a node of the two switching elements Q31 and Q32. The other end of the second winding 39 is connected to a node of the two switching elements Q33 and Q34.

The capacitor C2 is a link capacitor or a smoothing capacitor.

One end of the capacitor C2 is connected to a node of the two switching elements Q31 and Q33, and the other end of the capacitor C2 is connected to a node of the two switching elements Q32 and Q34.

The series-connected bodies 35 and 36 are connected in parallel to the capacitor C2.

The DC filter 13 is arranged between the series-connected body 36 and the battery pack 41. The DC filter 13 reduces noise included in the DC power output from the series-connected body 36 and outputs the DC power to the battery pack 41.

The battery pack 41 includes a battery 42, a first positive conductor L1, a second positive conductor L2, a first negative conductor L3, a second negative conductor L4, and first to fourth switches 43 to 46.

The battery 42 includes rechargeable batteries that can be charged and discharged. The positive electrode of the battery 42 is connected to the first positive conductor L1. The negative electrode of the battery 42 is connected to the first negative conductor L3.

The first positive conductor L1 serves as a positive conductor configured to connect the charger 11 to the positive electrode of the battery 42. The first negative conductor L3 serves as a negative conductor configured to connect the charger 11 to the negative electrode of the battery 42. In this embodiment, the first positive conductor L1 and the first negative conductor L3 connect the DC filter 13 and the battery 42.

The first switch 43 is arranged in the first positive conductor L1. The first switch 43 is, for example, a relay switch. The first switch 43, which is arranged in the first positive conductor L1, acts as a first switching unit that is switchable to connect or disconnect the charger 11 and the battery 42. The first switch 43 is turned on to connect the charger 11 to the battery 42 and turned off to disconnect the charger 11 from the battery 42.

The second switch 44 is arranged in the first negative conductor L3. The second switch 44 is, for example, a relay switch. The second switch 44 is switchable to connect or disconnect the charger 11 and the battery 42. The second switch 44 is turned on to connect the charger 11 to the battery 42 and turned off to disconnect the charger 11 from the battery 42.

The second positive conductor L2 connects the positive electrode of the battery 42 and the inverter 51. The second negative conductor L4 connects the negative electrode of the battery 42 and the inverter 51.

The third switch 45 is arranged in the second positive conductor L2. The third switch 45 is, for example, a relay switch. The third switch 45 is switchable to connect or disconnect the battery 42 and the inverter 51. The third switch 45 is turned on to connect the battery 42 to the inverter 51 and turned off to disconnect the battery 42 from the inverter 51.

The fourth switch 46 is arranged in the second negative conductor L4. The fourth switch 46 is, for example, a relay switch. The fourth switch 46 is switchable to connect or disconnect the battery 42 and the inverter 51. The fourth switch 46 is turned on to connect the battery 42 to the inverter 51 and turned off to disconnect the battery 42 from the inverter 51.

The battery pack 41 includes a voltage sensor 47. The voltage sensor 47 detects the voltage at the battery 42.

The inverter 51 is a three-phase inverter. The inverter 51 includes three series-connected bodies 52, 53, and 54. The series-connected bodies 52, 53, and 54 are connected in parallel to one another. The series-connected body 52 includes a U-phase upper-arm switching element Q41 and a U-phase lower-arm switching element Q42. The U-phase upper-arm switching element Q41 and the U-phase lower-arm switching element Q42 are connected in series between the second positive conductor L2 and the second negative conductor L4. The series-connected body 53 includes a V-phase upper-arm switching element Q43 and a V-phase lower-arm switching element Q44. The V-phase upper-arm switching element Q43 and the V-phase lower-arm switching element Q44 are connected in series between the second positive conductor L2 and the second negative conductor L4. The series-connected body 54 includes a W-phase upper-arm switching element Q45 and a W-phase lower-arm switching element Q46. The W-phase upper-arm switching element Q45 and the W-phase lower-arm switching element Q46 are connected in series between the second positive conductor L2 and the second negative conductor L4. The U-phase upper-arm switching element Q41, the U-phase lower-arm switching element Q42, the V-phase upper-arm switching element Q43, the V-phase lower-arm switching element Q44, the W-phase upper-arm switching element Q45, and the W-phase lower-arm switching element Q46 are, for example, semiconductor switching elements. The inverter 51 is connected by the second positive conductor L2 and the second negative conductor L4 to the battery 42.

The motor 61 is a three-phase motor. The motor 61 includes three coils 62, 63, and 64. The three coils 62, 63, and 64 are star-connected. A first end of the coil 62 is connected to a node of the U-phase upper-arm switching element Q41 and the U-phase lower-arm switching element Q42. A first end of the coil 63 is connected to a node of the V-phase upper-arm switching element Q43 and the V-phase lower-arm switching element Q44. A first end of the coil 64 is connected to a node of the W-phase upper-arm switching element Q45 and the W-phase lower-arm switching element Q46. A second end of the coil 62, a second end of the coil 63, and a second end of the coil 64 are connected to one another. A node of the second end of the coil 62, the second end of the coil 63, and the second end of the coil 64 is a neutral point N of the motor 61.

The power converter 10 includes a connection line 71. The connection line 71 connects a node between the charger 11 and the first switch 43 in the first positive conductor L1 to the neutral point N of the motor 61.

The power converter 10 includes a second switching unit 72. The second switching unit 72 is arranged in the connection line 71 to connect or disconnect the first positive conductor L1 and the neutral point N of the motor 61. The second switching unit 72 is, for example, a relay switch. The second switching unit 72 is turned on to connect the first positive conductor L1 to the neutral point N of the motor 61 and turned off to disconnect the first positive conductor L1 from the neutral point N of the motor 61.

The power converter 10 includes a controller 81. The controller 81 includes a processor and storage. Examples of the processor include a central processing unit (CPU), a graphics processing unit (GPU), and a digital signal processor (DSP). The storage includes a random-access memory (RAM) and a read-only memory (ROM). The storage stores program codes or instructions configured to have the processor execute a process. The storage, or a computer readable medium, includes any type of medium that is accessible by a general-purpose computer or a dedicated computer. The controller may include a hardware circuit such as an application specific integrated circuit (ASIC) or a field programmable gate array (FPGA). The controller, which acts as processing circuitry, may include one or more processors that run on computer programs, one or more hardware circuits such as an ASIC and an FPGA, or a combination of such devices.

The controller 81 controls the power converter 10. In this embodiment, the controller 81 totally controls the power converter 10. The power converter 10 may be controlled by more than one controller. For example, the power converter 10 may include a controller that controls the charger 11, a controller that controls the battery pack 41, and a controller that controls the inverter 51. The controller 81 is configured to acquire the detection result of the voltage sensor 47.

Propelling Control Executed by Controller when Propelling Vehicle

Propelling control executed by the controller 81 when propelling the vehicle will now be described.

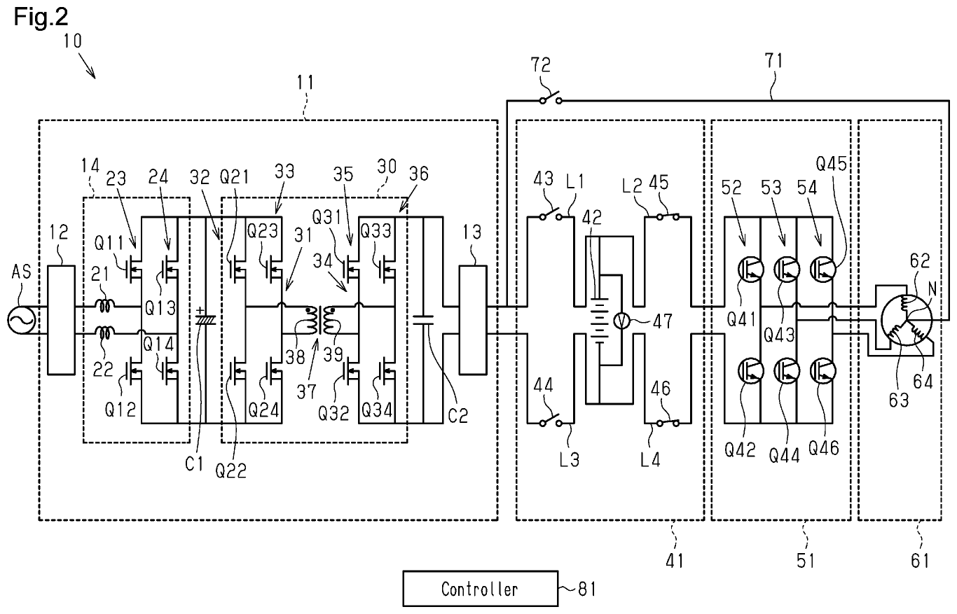

As shown in FIG. 2, the controller 81 turns on the third switch 45. The controller 81 also turns on the fourth switch 46. Further, the controller 81 turns off the second switching unit 72. The first switch 43 and second switch 44 may be off or on. This allows the inverter 51 to be supplied with the DC power discharged from the battery 42.

The controller 81 controls the inverter 51 so that the inverter 51 converts the input DC power from the battery 42 into AC power and outputs the AC power. The AC power output from the inverter 51 is input to the motor 61. The motor 61 is driven by the input AC power, propelling the vehicle. The motor 61 is a traction motor that propels the vehicle. The inverter 51 is a traction inverter that drives the traction motor.

### Charge Control Executed by Controller During Battery Charging

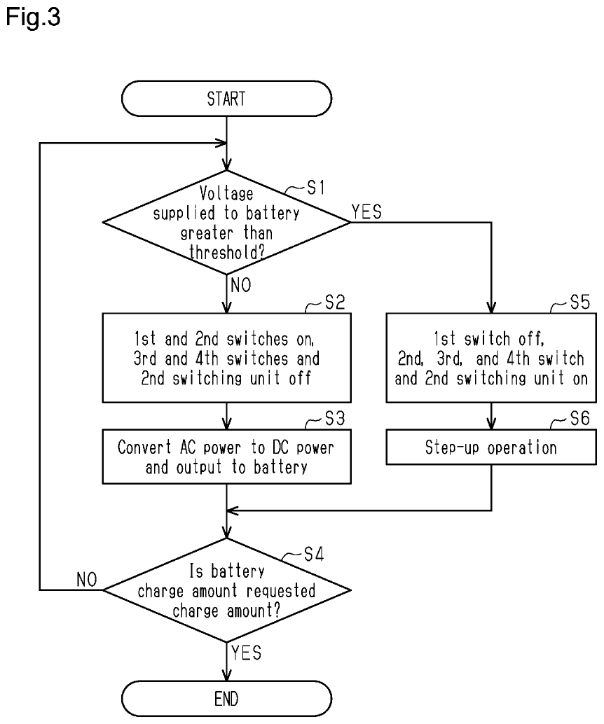

Charge control executed by the controller 81 when the battery 42 is charged will now be described with reference to FIGS. 3 to 5. Charge control is executed when, for example, the charger 11 and the external AC power supply AS are connected. Connection of the charger 11 and the external AC power supply AS may be detected when, for example, the controller 81 detects that a charge plug has been connected to the vehicle.

First, in step S1, the controller 81 determines whether the voltage that is to be supplied to the battery 42 is greater than a threshold voltage. In this embodiment, the controller 81 receives a requested voltage that is based on the charge amount of the battery 42. The requested voltage corresponds to the voltage that is to be supplied to the battery 42. The threshold voltage in this embodiment is the maximum voltage that the charger 11 is capable of outputting.

When the result of the determination made in step S1 is NO, the controller 81 proceeds to step S2.

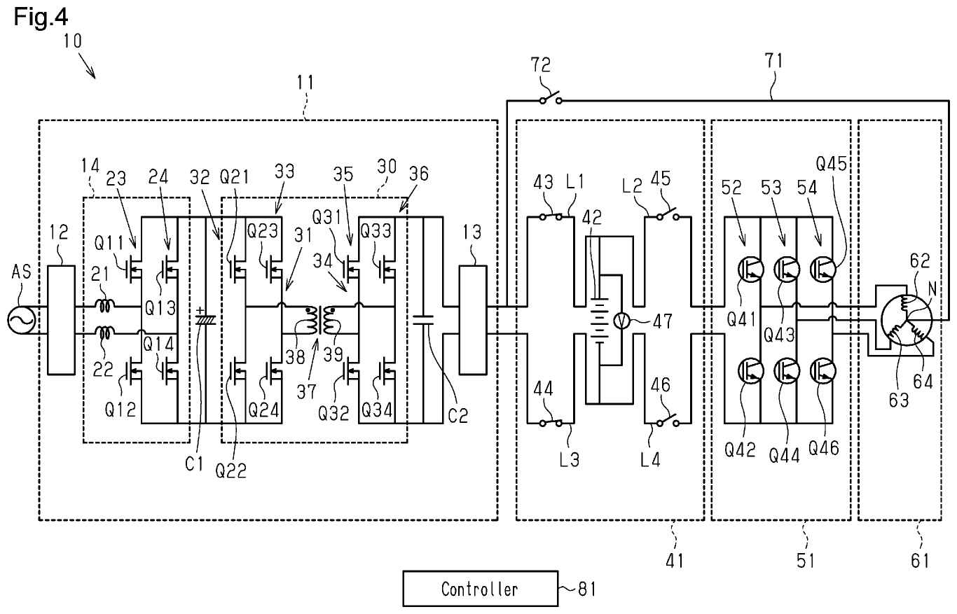

In step S2, as shown in FIG. 4, the controller 81 turns on the first switch 43 and the second switch 44, and turns off the third switch 45, the fourth switch 46, and the second switching unit 72. Then, the controller proceeds to step S3.

In step S3, the controller 81 controls the charger 11 so that the charger 11 converts AC power into DC power and outputs the DC power to the battery 42. The DC power output from the charger 11 charges the battery 42.

The controller 81 then proceeds to step S4 and determines whether the charge amount of the battery 42 has reached the requested charge amount. The voltage of the battery 42 may be used to determine whether the charge amount of the battery 42 has reached the requested charge amount. When the power converter 10 includes a battery management system that monitors the status of the battery 42, the controller 81 may acquire the state of charge of the battery 42 from the battery management system to determine whether the charge amount of the battery 42 has reached the requested charge amount.

When the result of the determination made in step S4 is NO, the controller 81 returns to step S1. When the result of the determination made in step S4 is YES, the controller 81 ends the charge control.

When the result of the determination made in step S1 is YES, the controller 81 proceeds to step S5.

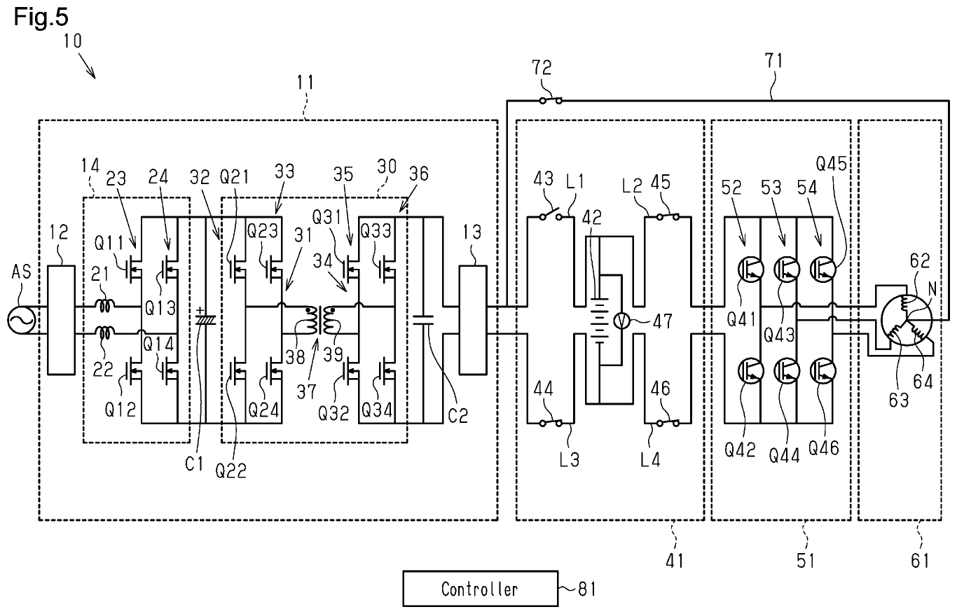

In step S5, as shown in FIG. 5, the controller 81 turns off the first switch 43, and turns on the second switch 44, the third switch 45, the fourth switch 46, and the second switching unit 72. Then, the controller 81 proceeds to step S6.

In step S6, the controller 81 controls the charger 11 to convert AC power into DC power. Further, the controller 81 controls the inverter 51 to perform a step-up operation that increases the output power voltage of the charger 11 with the motor 61 and the inverter 51. In this embodiment, the controller 81 alternately performs a first operation and a second operation to perform the step-up operation. In the first operation, the controller 81 simultaneously turns off the upper-arm switching elements Q41, Q43, and Q45 and simultaneously turns on the lower-arm switching elements Q42, Q44, and Q46. In the second operation, the controller 81 simultaneously turns on the upper-arm switching elements Q41, Q43, and Q45 and simultaneously turns off the lower-arm switching elements Q42, Q44, and Q46. The first operation is performed to store electromagnetic energy in the coils 62, 63, and 64. The second operation is performed to release the electromagnetic energy stored in the coils 62, 63, and 64 to the battery 42. This increases the voltage of the DC power through the step-up operation of the inverter 51. The DC power is output to the battery 42 to charge the battery 42.

The controller 81 then proceeds to step S4.

### Operation of Embodiment

Even if the battery 42 is to be supplied with power that is greater than or equal to the maximum power that the charger 11 is capable of outputting, the power converter 10 will increase the voltage of the DC power output from the charger 11 with the motor 61 and the inverter 51 and supply the battery 42 with the DC power that has been increased in voltage.

### Advantages of Embodiment

(1) The power converter 10 includes the first switch 43, the connection line 71, and the second switching unit 72. The controller 81 turns off the first switch 43 and turns on the second switching unit 72 to increase the voltage of the DC power output from the charger 11 with the motor 61 and the inverter 51 and supply the battery 42 with the DC power that has been increased in voltage. Thus, the power converter 10 is able to supply the battery 42 with power exceeding the maximum power that the charger 11 is capable of outputting. That is, the power converter 10 is able to apply voltage exceeding the maximum voltage that the charger 11 is capable of outputting to the battery 42.
(2) The output voltage range of the power converter 10 can be widened without using a step-up circuit.
(3) In a counterexample, if the charger 11 were to output high power (high voltage), high voltage would be applied to semiconductor switching elements of the charger 11. Thus, the semiconductor elements would have to be selected that can withstand high voltages. However, in the present embodiment, the inverter 51, which supplies power to the motor 61 (traction motor), supplies the motor 61 with power that is higher than the power supplied by the charger 11. Thus, the semiconductor switching elements of the inverter 51 are used to withstand higher voltages than the semiconductor switching elements of the charger 11.

Compared to the above counterexample, in the power converter 10 of the present embodiment, when the battery 42 is to be supplied with power that is greater than the power that the charger 11 is capable of outputting, the motor 61 and the inverter 51 are used to increase the voltage of the power. This allows for the use of relatively inexpensive semiconductor switching elements in the charger 11.

### Modified Examples

The above embodiment may be modified as described below. The above embodiment and the following modifications can be combined as long as there is no technical contradiction.

The battery pack 41 of the above embodiment does not have to include the second switch 44.

The battery pack 41 does not have to include one or both of the third switch 45 and the fourth switch 46.

The charger 11 may have any structure as long as it converts the input AC power to DC power.

The DC/DC converter 30 of the above embodiment may have any structure as long as it transfers DC power from the first bridge circuit 31 to the second bridge circuit 34.

When using the motor 61 and the inverter 51 to perform a step-up operation, the controller 81 of the embodiment may turn on and off the upper-arm switching elements Q41, Q43, and Q45 and the lower-arm switching elements Q42, Q44, and Q46 through an interleaved control method that shifts the switching times of different phases.

In the above embodiment, the threshold voltage is set to the maximum voltage that the charger 11 is capable of outputting. Instead, the threshold voltage may be set to the maximum voltage that the charger 11 is capable of outputting at a predetermined power conversion efficiency. Typically, in the voltage output range of the charger 11, the power conversion efficiency increases as the voltage increases from the minimum value. After the power conversion efficiency reaches a peak at a certain voltage, the power conversion efficiency decreases as the voltage further increases. Thus, the charger 11 may be used in a state in which the power conversion efficiency is high by setting the threshold voltage to the maximum voltage that the charger 11 is capable of outputting at the predetermined power conversion efficiency.

In the above embodiment, a threshold voltage is set. Instead, a threshold power may be set. In this case, the threshold is compared with the power that is to be supplied to the battery 42 instead of the voltage that is to be supplied to the battery 42.

The motor 61 of the above embodiment may be used in a motor-driven compressor. The inverter 51 may be used to drive a motor of a motor-driven compressor.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A power converter, comprising:
a charger configured to convert input alternating current (AC) power into direct current (DC) power;
a battery connected to the charger and supplied with DC power that is output from the charger;
an inverter connected to the battery and configured to be supplied with DC power that is output from the battery;
a motor connected to the inverter and including three star-connected coils, wherein the motor is configured to be supplied with AC power that is output from the inverter;
a positive conductor connecting the charger to a positive electrode of the battery;
a negative conductor connecting the charger to a negative electrode of the battery;
a first switching unit arranged in the positive conductor and configured to connect or disconnect the charger and the battery;
a connection line connecting a node between the charger and the first switching unit in the positive conductor to a neutral point of the motor; and
a second switching unit arranged in the connection line and configured to connect or disconnect the positive conductor and the neutral point of the motor.

2. The power converter according to claim 1, further comprising:
processing circuitry, wherein
the processing circuitry is configured to turn on the first switching unit in order to connect the charger to the battery and turn off the first switching unit in order to disconnect the charger from the battery,
the processing circuitry is configured to turn on the second switching unit in order to connect the positive conductor to the neutral point of the motor and turn off the second switching unit in order to disconnect the positive conductor from the neutral point of the motor, and
the processing circuitry is configured to charge the battery by performing a step-up operation with the inverter while turning off the first switching unit and turning on the second switching unit.

3. The power converter according to claim 2, wherein
when the voltage that is to be supplied to the battery is less than or equal to a threshold voltage, the processing circuitry is configured to charge the battery while turning on the first switching unit and turning off the second switching unit, and
when the voltage that is to be supplied to the battery is greater than the threshold voltage, the processing circuitry is configured to charge the battery by performing a step-up operation with the inverter while turning off the first switching unit and turning on the second switching unit.
